(19) United States
(12) Patent Application Publication
(10) Pub. No.: US 2014/0151525 A1
(43) Pub. Date: Jun. 5, 2014

(54) PORTABLE HOLDING DEVICE

(71) Applicant: Tong Hsin Cheng, Taipei (TW)

(72) Inventor: Tong Hsin Cheng, Taipei (TW)

(73) Assignee: Acro Work International Corp., Taipei (TW)

(21) Appl. No.: 13/691,694

(22) Filed: Nov. 30, 2012

(51) Int. Cl. F16M 13/02

(52) U.S. Cl. CPC F16M 13/02
USPC 248/467; 248/205.3

(57) ABSTRACT

A portable holding device for mounting an item comprises a bottom component, a top component, an adhesive pad, and a mounting component. When the portable holding device is not used to mount an item, the adhesive pad may be covered by the top component. When the portable holding device is used to mount an item, the top component is unfolded to expose the adhesive pad, the adhesive pad is then attached to a desired location, and the mounting component is used to mount the item, which may be personal apparel, umbrellas, handbags, glasses, pens, and small tools.

### BACKGROUND

1. Field of the Invention

The present invention relates generally to a portable holding device and, more particularly, to a portable device that has a coverable adhesive pad.

2. Description of the Related Art

A holding device is used to hold an object onto a desired surface. It usually comprises a fixation unit that fixes the holding device onto the desired surface, and an attachment unit that holds the object. For example, a wall hanger has an adhesive pad and a hook. The adhesive pad fixes the wall hanger onto the desired location, and the hook can be used to hang objects, such as coats, handbags, and umbrellas.

For conventional holding device, once the holding device is fixed onto the desired location, the holding device cannot be easily removed without damaging the wall or the holding device.

Therefore, there is a need in the art to provide a holding device that is portable.

### SUMMARY

An object of the present invention is to provide a holding device that is portable.

According to one embodiment of the present invention, a portable holding device for mounting an item may comprise a bottom component, an adhesive pad on the bottom component, and a mounting component adapted to mount the item. The portable holding device may also comprise a top component capable of covering the adhesive pad when the adhesive pad is not used.

According to embodiments of the present invention, the counting component may be a hook, a basket, a bar, a knob, a clip, stationery, a toy, or a LED. According to embodiments of the present invention, the portable holding device may have multiple configurations. In one configuration, the portable holding device may be adapted to wall mounting. In another configuration, the portable holding device may be adapted to desktop mounting. In yet another configuration, the portable holding device may be adapted to hold coins or a cell phone. In yet another configuration, the portable holding device may be a desktop mirror.

### BRIEF DESCRIPTION OF THE DRAWINGS

The described embodiments of the present invention will be apparent through examination of the following detailed description in conjunction with the accompanying drawings, in which:

FIG. 1A is a top view of the portable holding device according to an embodiment of the present invention.

FIG. 1B is a sectional view of the portable holding device according to an embodiment of the present invention.

FIG. 1C is a side view of the portable holding device according to an embodiment of the present invention.

FIG. 2A is a sectional view of the portable holding device in a configuration according to an embodiment of the present invention.

FIG. 2B is a sectional view of the portable holding device in another configuration according to an embodiment of the present invention.

FIG. 3A is a sectional view of the portable holding device for wall mounting according to an embodiment of the present invention.

FIG. 3B is a sectional view of the portable holding device for wall mounting according to another embodiment of the present invention.

FIG. 3C is a sectional view of the portable holding device for wall mounting according to another embodiment of the present invention.

FIG. 4A is a sectional view of the portable holding device for desktop usage according to an embodiment of the present invention.

FIG. 4B is a sectional view of the portable holding device for desktop usage according to another embodiment of the present invention.

FIG. 5A is a sectional view of the portable holding device for desktop usage according to another embodiment of the present invention.

FIG. 5B is a sectional view of the portable holding device for desktop usage according to another embodiment of the present invention.

FIG. 6A is a sectional view of the portable holding device for edge mounting according to an embodiment of the present invention.

FIG. 6B is a sectional view of the portable holding device for edge mounting according to another embodiment of the present invention.

### DETAILED DESCRIPTION

To be consistent throughout the description and for clear understanding of the present invention, the following definitions are hereby provided:

The term “holding device” refers to a device adapted to mount an item onto a desired location. For example, the holding device may mount a handbag on a wall, or at the edge of a desktop. In addition, the holding device may mount coins or other personal accessories on top of the holding device itself.

The term “portable holding device” refers to a holding device that is removable from the mounted location without damaging the portable holding device or the mounted location.

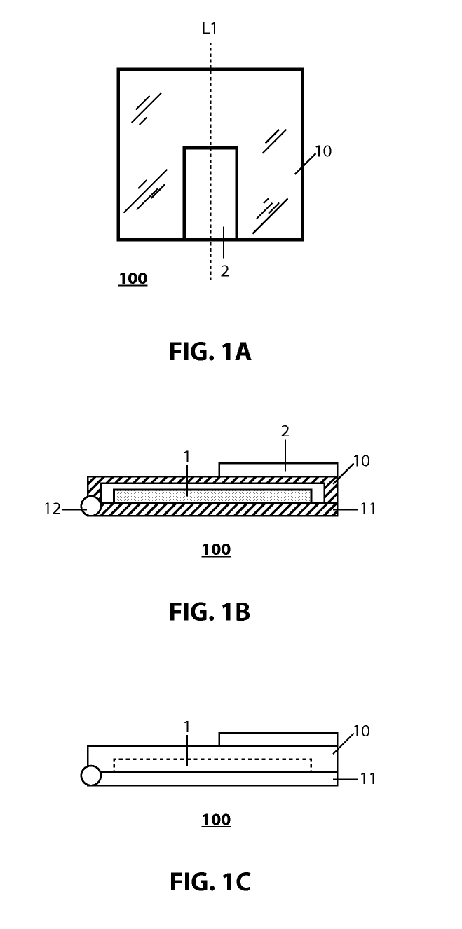

FIG. 1A is a top view of the portable holding device 100 according to an embodiment of the present invention. As shown, the portable holding device 100 comprises a top component 10 and the mounting component 2.

FIG. 1B is a sectional view of the portable holding device along the line L1 in FIG. 1A. The portable holding device 100 is at a folded configuration. As shown, the portable holding device 100 comprises a bottom component 11, an adhesive pad 1, a top component 10, a connection unit 12, and a mounting component 2. The adhesive pad 1 may be fixed onto the inner surface of the bottom component 11 by glue or some other means. At the folded configuration illustrated in FIG. 1A, the top component 10 covers the adhesive pad 1 so that the portable holding device 100 may be transported without exposing the adhesive pad 1, which may hinder the transportation and may attract dirt or other unwanted objects.

The front shape of the top component 10 may, for example, be a triangle, a rectangle, a polygon, a circle, an irregular shape, or a cartoon shape. The shape of the bottom component 11 may be substantially similar to the shape of the top component 10. In addition, the bottom component 11 may have a different shape tan the top component 10. For example, the top component 10 may have a cartoon cat shape, and the bottom component 11 may have a cartoon fish shape, whereas the top component 10 substantially covers the adhesive pad 1. In addition, drawings or logos may be placed or imprinted on the outer surfaces of the top component 10 and the bottom component 11.

The connection unit 12 may be used to connect the top component 10 to the bottom component 11. A person of ordinary skill in the art would recognize that the top component 10 and the bottom component 11 may be connected through other means, or they may be integrally formed. The scope of the present invention is not limited to the exact connection mechanism of the top component 10 and the bottom component 11. For example, the top component 11 may use the connection unit 12 as a folding pivot to cover the adhesive pad 1. Alternatively, the top component 11 may also apply a sliding mechanism such that the adhesive pad 1 is exposed when the top component 11 is slid outward.

The adhesive pad 1 may be Polyether Casting Elastomer, PU GEL, or Polyurethane Gel Elastomers, which may offer good adhesion, flexibility, durability, and UV stability. In addition, PU GEL may be cleared by water to restore its original property. It can also be easily peeled off from a surface without leaving marks or residue. A person of ordinary skill in the art would recognize that the adhesive pad 1 may be other kinds of sticky or frictional pads that can adhere the portable holding device onto the desired location. The adhesive pad 1 may comprise more than one layer, may be of any shape, and may locate at a different part on the bottom component 11. The adhesive pad 1 may also be made of adhesives, such as removable contact adhesives, removable pressure sensitive adhesives and removable tapes. In addition, the adhesive pad 1 may be replaced with a suction disk, or multiple suction disks, to adhere the portable holding device onto the desired location.

The mounting component 2 may be adapted to mount items, such as clothes, umbrellas, handbags, glasses, tools, and toys or stationery. In addition, it may incorporate a level system that incorporates multiple replaceable mounting units, each suitable for a specific purpose. For example, one mounting unit may be a hook adapted to mount clothes, another mounting unit may be a basket adapted to mount soaps, and another mounting unit may be a stand adapted to mount glasses. In addition, the mounting component 2 may also be a light source, such as a light-emitting diode (LED) light source, to offer illumination. The purpose of the present invention is not limited by the location or the exact mounting mechanism of the mounting component 2. Instead, a person of ordinary skill in the art would appreciate that the mounting component 2 may be located on other places of the portable mounting device 100, and may use other mounting mechanism adapted to mount targeted items.

FIG. 1C is a side view of the portable holding device 100 according to an embodiment of the present invention. The portable holding device 100 is at a folded configuration. As shown, the adhesive pad 1 is enclosed by the top component 10 and the bottom component 11.

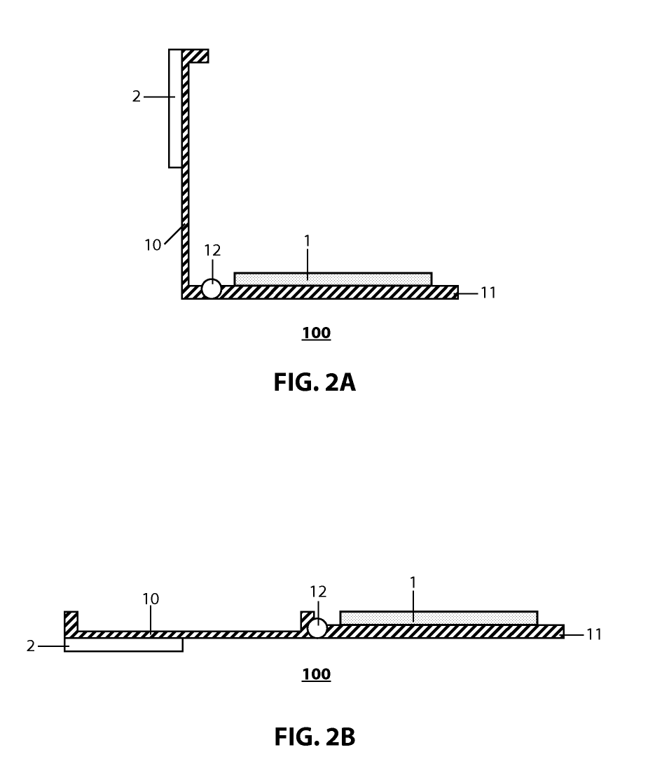

FIG. 2A is a sectional view of the portable holding device 100 in a half-folded configuration according to an embodiment of the present invention. As shown, the top component 10 exposes the adhesive pad 1 by rotating along the connection unit 12, which connects the top component 10 to the bottom component 11. In this configuration, the mounting component 2 is unfolded along with the top component 10, and may be suitable for mounting items.

FIG. 2B is a sectional view of the portable holding device 100 in an unfolded configuration according to an embodiment of the present invention. As shown, the top component 10 exposes the adhesive pad 1 by rotating along the connection unit 12 such that the top component 10 is substantially alongside the bottom component 11. In this configuration, the mounting component 2 is unfolded along with the top component 10, and may be suitable for mounting items.

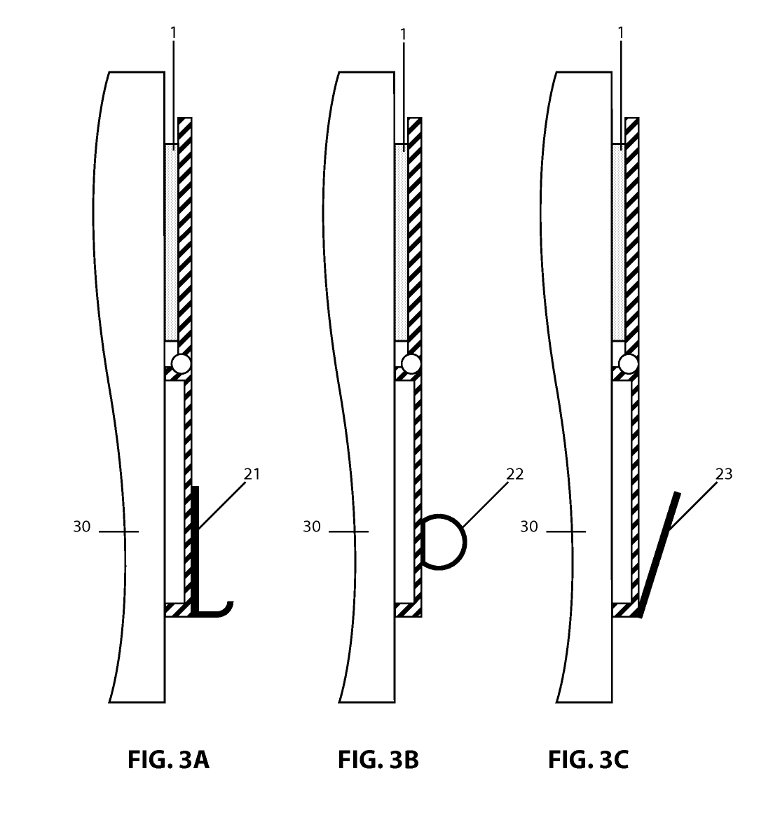

FIGS. 3A-3C are sectional views of the portable holding device for wall mounting according to embodiments of the present invention. As show, the portable holding device is affixed onto the wall 30 through the adhesive pad 1. Once affixed, the portable holding device may use its mounting component to mount the desired items. For example, in FIG. 3A, the mounting component 21 is a hook. In FIG. 3B, the mounting component 22 is a knob. Alternatively, it may also be a LED light source. In FIG. 3C, the mounting component 23 is a bar. As previously mentioned, these mounting components may be located on other places of the portable holding device.

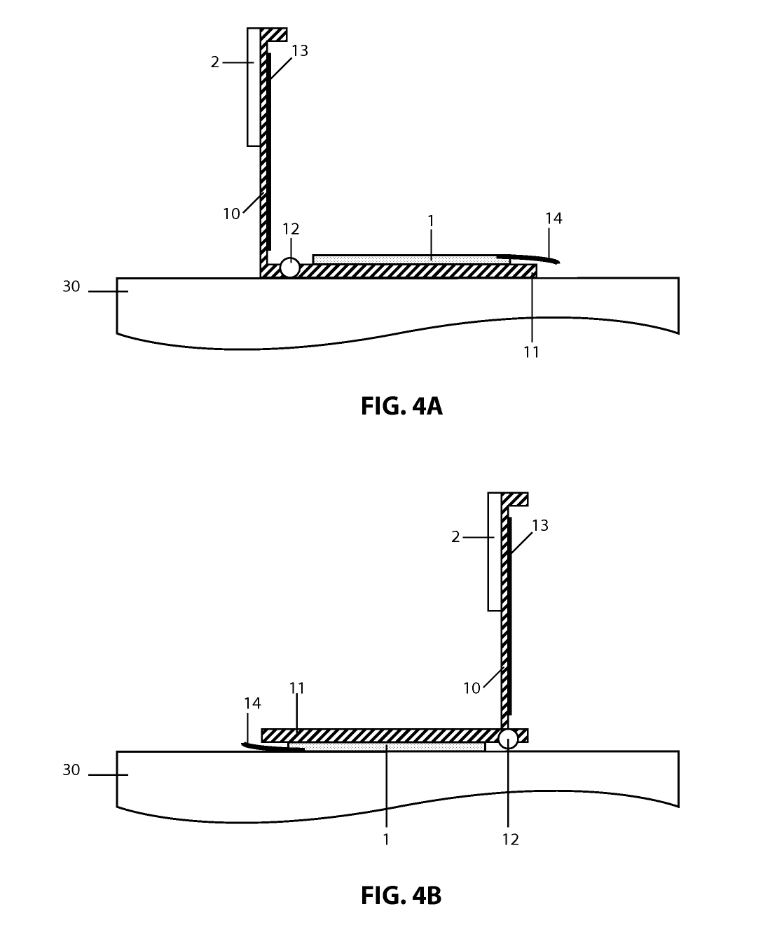

FIG. 4A is a sectional view of the portable holding device for desktop usage according to an embodiment of the present invention. As shown, the top component 10 exposes the adhesive pad 1 by rotating along the connection unit 12. The bottom component 11 is placed on top of the desktop 30. In this configuration, the mounting component 2 may be used to mount suitable items. The portable holding device also comprises a mirror 13 on the inner surface of the top component 10. This allows a user to use the mirror 13 when the portable holding device is placed on the desktop. In addition, the portable holding device comprises a removal unit 14 adapted to allow easy removal of the adhesive pad 1 from an affixed surface. This removal unit 14 may also be similarly adopted by other embodiments of the present invention.

FIG. 4B is a sectional view of the portable holding device for desktop usage according to another embodiment of the present invention. As shown, the top component 10 exposes the adhesive pad 1 by rotating along the connection unit 12. The bottom component 11 of the portable holding device is affixed on top of the desktop 30 through the adhesive pad 1. The portable holding device may be removed from the desktop 30 by pulling the removal unit 14 upward. In this configuration, the mounting component 2 may be used to mount suitable items. The portable holding device also comprises a mirror 13 on the inner surface of the top component 10.

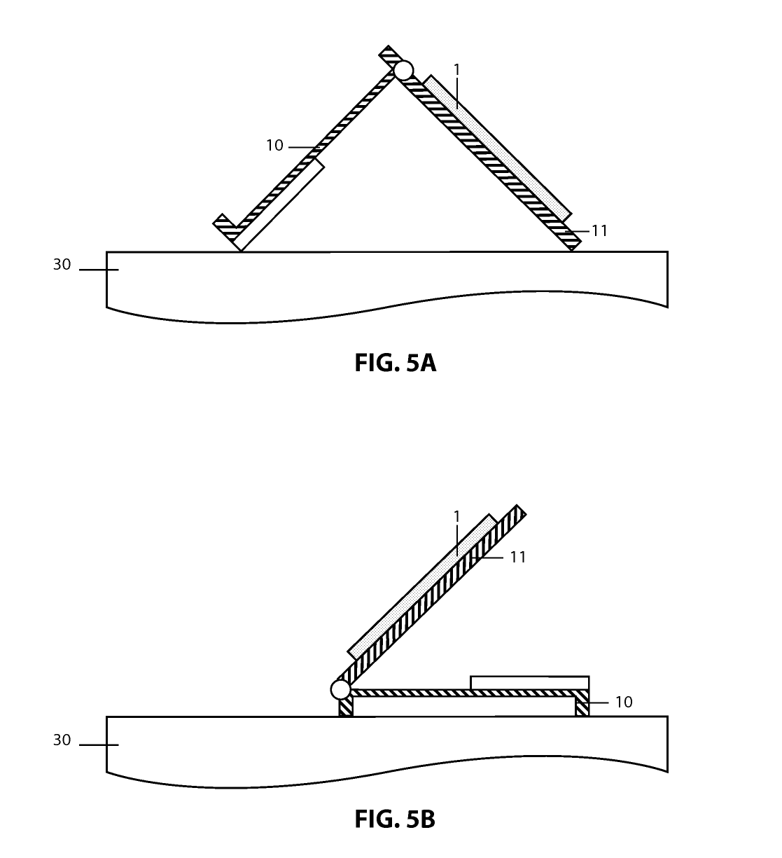

FIGS. 5A-5B are sectional views of the portable holding device for desktop usage according to other embodiments of the present invention. In FIG. 5A, the portable holding device is placed on top of the desktop 30 through the top component 10 and the bottom component 11. The adhesive pad 1 may provide a frictional surface used to mount items such as coins, glasses, cell phones, pens, wallets, and keys. Similarly, in FIG. 5B, the portable holding device is placed on top of the desktop 30 through the top component 10, and the adhesive pad 1 may provide a frictional surface suitable for mounting items.

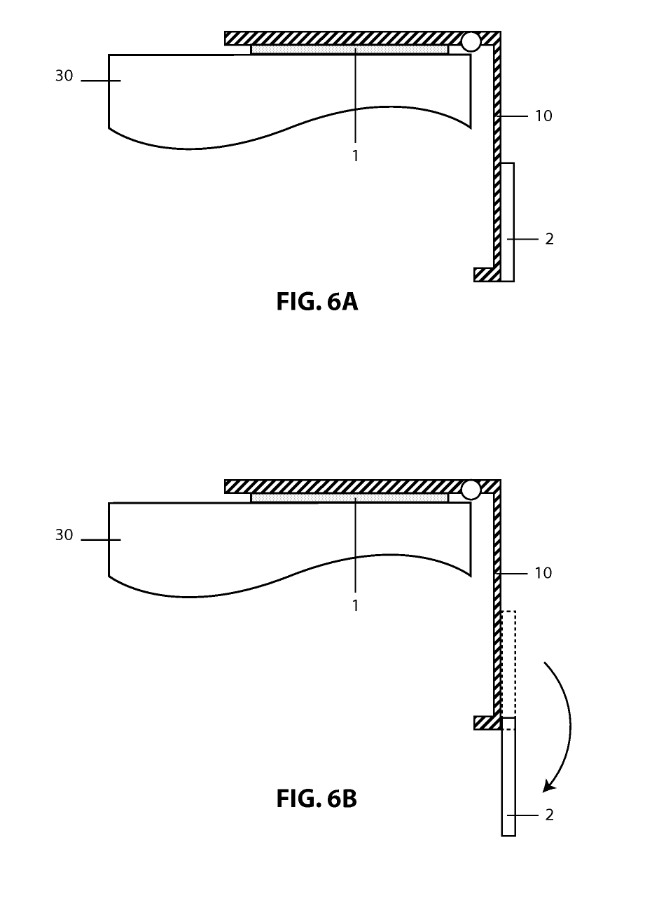

FIGS. 6A-6B are sectional views of the portable holding device for edge mounting according to embodiments of the present invention. As shown, the portable holding device is affixed onto the desktop 30 through the adhesive pad 1, thereby allowing the top component 10 to be aligned substantially alongside the edge of the desktop 30. In FIG. 6A, the mounting component 2 may be adapted to mount items such as handbags. In addition, as shown in FIG. 6B, the mounting component 2 may be further folded downward to mount suitable items.

What is claimed is:

1. A portable holding device for mounting an item, comprising:
a bottom component;
an adhesive pad on the bottom component;
a top component connected to the bottom component through a connection unit; and
a mounting component fixed on an outer surface of the top component, and adapted to mount the item,
whereas in a first configuration the top component covers the adhesive pad.

2. The portable holding device of claim 1, wherein the adhesive pad is adapted to adhere the portable holding device onto a desired location and can be cleared by water to restore the adhesive pad's adhesive property.

3. The portable holding device of claim 1, wherein the adhesive pad comprises PU gel.

4. The portable holding device of claim 1, wherein the adhesive pad comprises at least one suck disk.

5. The portable holding device of claim 3, wherein the top component has a rectangular shape.

6. The portable holding device of claim 3, wherein the top component has a shape according to a cartoon character.

7. The portable holding device of claim 3, wherein the outer surface of the top component comprises a commercial logo.

8. The portable holding device of claim 3, wherein the mounting component comprises a hook.

9. The portable holding device of claim 3, wherein the mounting component comprises a LED light source.

10. The portable holding device of claim 3, wherein the mounting component comprises a bar.

11. The portable holding device of claim 3, wherein the mounting component comprises a basket.

12. The portable holding device of claim 3, wherein the mounting component comprises a replaceable system adapted to connect with a plurality of sub-mounting units.

13. The portable holding device of claim 8, further comprising a removable unit adapted to facilitate removing the adhesive pad from a desired location.

14. The portable holding device of claim 13, wherein in a second configuration the adhesive pad is attached to a wall surface, and the top component is substantially parallel to the wall surface.

15. The portable holding device of claim 14, wherein the mounting component is a hook and the item is apparel.

16. The portable holding device of claim 14, wherein in a third configuration the adhesive pad is attached to a desktop surface of a desktop edge, and the top component is substantially perpendicular to the desktop surface.

17. The portable holding device of claim 16, wherein the mounting component is a hook and the item is a handbag.

18. The portable holding device of claim 13, wherein in a forth configuration the top component is placed on a desktop, and the adhesive pad provides a frictional surface to secure the item.

19. The portable holding device of claim 18, wherein the item is a mobile phone.

20. The portable holding device of claim 3, further comprising a mirror attaching an inner surface of the top component.
